(19) United States
(12) Patent Application Publication
(10) Pub. No.: US 2008/0085730 A1
(43) Pub. Date: Apr. 10, 2008

(54) System and Method for Message Monitoring and Identification

(75) Inventor: Robert C. Lovell Jr., Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 11/867,855

(22) Filed: Oct. 5, 2007

Related U.S. Application Data
(60) Provisional application No. 60/828,842, filed on Oct. 10, 2006.

(51) Int. Cl. H04Q 7/20

(52) U.S. Cl. 455/466

(57) ABSTRACT

A service that leverages established wireless messaging paradigms such as, possibly inter alia, Short Message Service, Multimedia Message Service, and IP Multimedia Subsystem to yield an infrastructure that supports a range of mechanisms (including, for example, linguistic, statistical, heuristic, etc.) for the authoritative identification of the true author of a message (where the identification of the true author of a message may take into consideration, among other things, that the sender of the message may in fact not be the actual author of the message). The service may optionally leverage the capabilities of a centrally-located Messaging Inter-Carrier Vendor.

This application claims the benefit of U.S. Provisional Patent Application No. 60/828,842, filed on Oct. 10, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various messaging paradigms including, inter alia, Short Message Service (SMS), Multimedia Message Service (MMS), Wireless Application Protocol (WAP), Internet Protocol (IP) Multimedia Subsystem (IMS), Instant Messenger (IM), etc.

2. Background of the Invention

As the ‘wireless revolution’ continues to march forward the importance to a Mobile Subscriber (MS), for example a user of a Wireless Device (WD) such as, inter alia, a cellular telephone, BlackBerry, etc. that is serviced by a Wireless Carrier (WC), of their WD grows substantially.

One consequence of such a growing importance is the resulting ubiquitous nature of WDs—i.e., MSs carry them at almost all times and use them for an ever-increasing range of activities.

Under a variety of circumstances it may be desirable to examine the body or contents of a (SMS, MMS, IM, etc.) message and, through a variety of means, authoritatively identify the true author of the message. The identification of the true author of a message may take into consideration, among other things, that the sender of the message (which may be discoverable through, for example, the source address—such as Telephone Number [TN]—of the message) may in fact not be the actual author of the message and may leverage a range of (linguistic, statistical, heuristic, etc.) methods to, inter alia, associate or link together like-authored messages and identify message authorship.

Such a message author identification capability may be useful, for example, during a criminal investigation by a law enforcement agency; for purposes of ensuring national/regional/local security by a governmental agency; during a marketing initiative or advertising campaign by a corporation; within a travel services firm; in connection with audience measurement, etc. programs within a movie, television, music, etc. company; etc. The examples that were just presented are illustrative only and it will be readily apparent to one of ordinary skill in the relevant art that numerous other examples are easily possible.

The present invention provides such a message author identification capability and addresses various of the (not insubstantial) challenges that are associated with same.

### SUMMARY OF THE INVENTION

Embodiments of the present invention provide a service that leverages established wireless messaging paradigms such as, possibly inter alia, SMS and MMS to yield an infrastructure that enables identification of message authorship based on patterns that can be gleaned in message traffic.

More specifically, in one embodiment of the present invention there is a provided a method including retrieving a plurality of messages passing through a wireless messaging environment, preserving elements of the messages in a database, processing the elements of the messages to make associations among the elements of the messages, identifying patterns in the elements of the messages, storing in the database the patterns as a plurality of associations, and determining probable common authorship of given messages based on the patterns and the plurality of associations. Based on results of this analysis, an alert may be sent to a law enforcement agency. That is, a person may be attempting to use, e.g., multiple telephone numbers in order to avoid detection or tracking. However, embodiments of the present invention operate to “look deeper” into the messaging itself to identify unique characteristics of an author's use of, e.g., language or timing of messages, among other things.

In one implementation, the plurality of messages is received at a messaging inter-carrier vendor (MICV). Preferably, a service provider that is unaffiliated with the MICV performs the pattern analysis. Such analysis may be based on keyword, linguistic style, and/or discrete phrases that are found within the messages themselves.

As noted, the messages may comprise short message service (SMS) messages or multimedia message service (MMS) messages.

In another embodiment of the present invention, there is provided a method of tracking messages sent by a person from different wireless devices, including collecting electronic message traffic from wireless devices, processing the electronic message traffic by parsing elements of respective messages in the electronic message traffic, analyzing the elements and identifying patterns among the elements and, thereby, among respective messages in the electronic message traffic, storing, in an associations database, a listing of identified patterns, and correlating given ones of the messages in the electronic message traffic with given ones of the identified patterns.

Based on these patterns, it may be possible to identify authors of various ones of the messages. Moreover, as more and more messages are received and analyzed, more precise patterns, and thus author identification, results. Once authorship can be associated with given ones of the messages, if is also then possible, in accordance with the present invention, to track respective times of transmission of the given ones of the messages. The methodology further provides for determining prior locations of the author based on locations and timing of initial transmission of respective ones of the given ones of the messages.

In the case the that electronic message traffic comprises short message service (SMS) electronic message traffic, then it is further possible in accordance with the present invention to correlate source telephone numbers of the author. Knowing the telephone numbers further permits identifying wireless carriers that provide service to the author, and may also help to determine service payment arrangements for the author, such that, e.g., law enforcement agencies, can track the finances of, e.g., criminal suspects.

These and other features of the embodiments of the present invention, along with their attendant advantages, will be more fully appreciated upon a reading of the following detailed description in conjunction with the associated drawings.

### BRIEF DESCRIPTION OF THE DRAWINGS

FIG. 1 is a diagrammatic presentation of an exemplary Messaging Inter-Carrier Vendor (MICV).

FIG. 2 illustrates one particular arrangement that is possible through aspects of the present invention.

FIG. 3 illustrates various of the exchanges or interactions that are supported by aspects of the present invention.

FIG. 4 is a diagrammatic presentation of aspects of an exemplary Service Provider (SP) Application Server (AS).

FIG. 5 depicts an exemplary logical data model that a SP might employ to support aspects of the present invention.

FIG. 6 illustrates various of the exchanges or interactions that are possible during the optional registration portion of the present invention.

FIG. 7 provides an exemplary catalog of some of the shortcuts that are frequently employed in SMS, MMS, etc. messages.

It should be understood that these figures depict embodiments of the invention. Variations of these embodiments will be apparent to persons skilled in the relevant art(s) based on the teachings contained herein.

### DETAILED DESCRIPTION

The present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same. The disclosure of U.S. Pat. No. 7,154,901, and its associated continuations, is incorporated herein by reference.

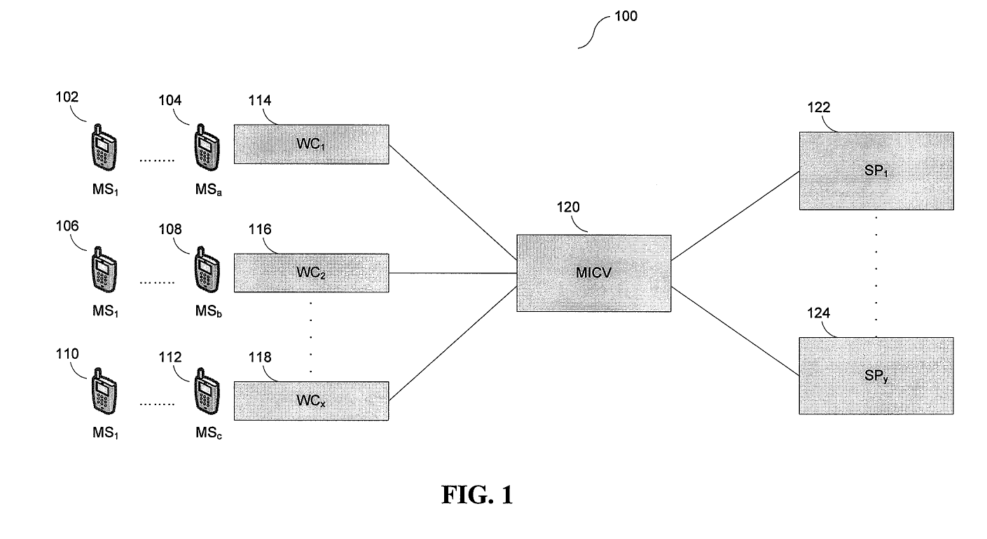

As illustrated by FIG. 1 and reference numeral 100 a MICV 120 is disposed between, possibly inter alia, multiple WCs (WC₁ 114→WCₓ 118) on one side and multiple SPs (SP₁ 122→SP_{y} 124) on the other side and thus ‘bridges’ all of the connected entities. A MICV 120 thus, as one simple example, may offer various routing, formatting, delivery, value-add, etc. capabilities that provide, possibly inter alia:

1) A WC, WC₁ 114→WCₓ 118 (and by extension all of the MSs [MS₁ 102→MSₐ 104, MS₁ 106→MS_{b} 108, MS₁ 110→MS_{c} 112] that are serviced by a WC [WC₁ 114→WCₓ 118]), with ubiquitous access to a broad universe of SPs (SP₁ 122→SP_{y} 124), and

2) A SP (SP₁ 122→SP_{y} 124) with ubiquitous access to a broad universe of WCs (WC₁ 114→WCₓ 118 and, by extension, to all of the MSs [MS₁ 102→MSₐ 104, MS₁ 106→MS_{b} 108, MS₁ 110→MS_{c} 112] that are serviced by a WC [WC₁ 114→WCₓ 118]).

Generally speaking a MICV may have varying degrees of visibility (e.g., access, etc.) to the (MS←→MS, MS←→SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

While the discussion below will include a MICV it will be readily apparent to one of ordinary skill in the relevant art that numerous other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

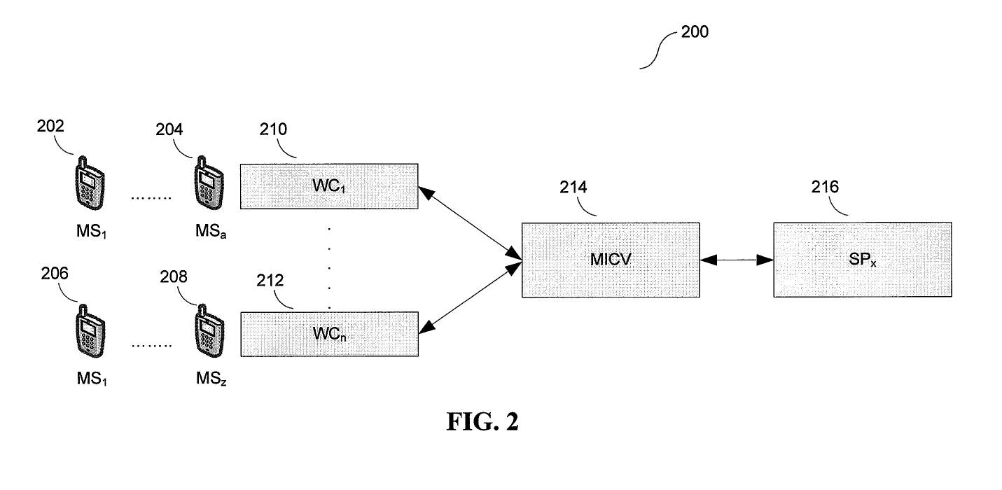

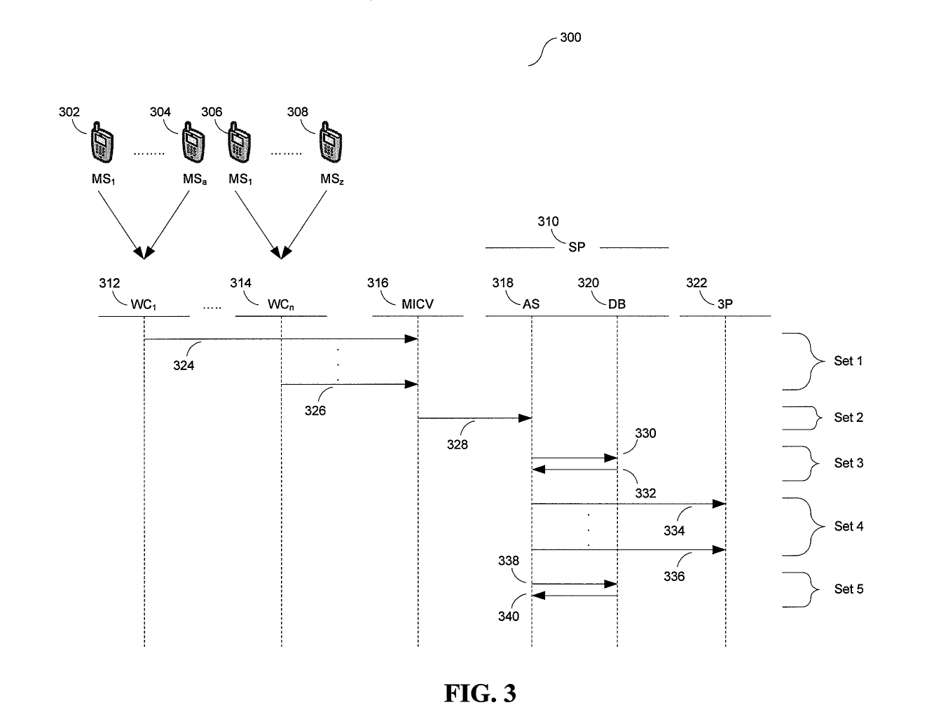

To help explain key aspects of the present invention consider the illustrative example that is depicted through FIG. 2, FIG. 3, and the narrative below.

As indicated in FIG. 2 and reference numeral 200, all of the messaging traffic of numerous WCs (WC₁ 210→WCₙ 212) is exchanged with a MICV 214 and the MICV 214 is connected with SPₓ 216 (a SP that offers, possibly inter alia, aspects of the present invention). Among other things this provides SPₓ 216 with visibility (access, etc.) to all of the messaging traffic and, inter alia, the opportunity (as explained below) to continuously expand its internal repositories, refine the results of its message author identification and other analytical activities, etc. as time progresses (and as ever more messages are presented to it).

FIG. 3 and reference numeral 300 illustrate various of the exchanges or interactions that might occur as (SMS, MMS, etc.) messaging traffic is, possibly inter alia, generated, routed, processed, etc. Of interest and note in the diagram are the following entities:

MS₁ 302→MSₐ 304 and MS₁ 306→MS_{z} 308. WDs such as a cellular telephones, BlackBerrys, PalmPilots, etc.

WC₁ 312→WCₙ 314. Numerous WCs that, possibly inter alia, provide service to the MSs (MS₁ 302→MSₐ 304 and MS₁ 306→MS_{z} 308).

MICV 316. As noted above the use of a MICV, although not required, provides significant advantages.

SP 310 AS 318. Facilities that provide key elements of the instant invention (which will be described below).

SP 310 Database (DB) 320. One or more data repositories that are leveraged by SPₓ's 310 AS 318.

3P 322. External third-parties (such as, inter alia, a federal/state/local/etc. law enforcement agency, a federal/state/local/etc. governmental agency, a representative of a corporation, an organization, etc.).

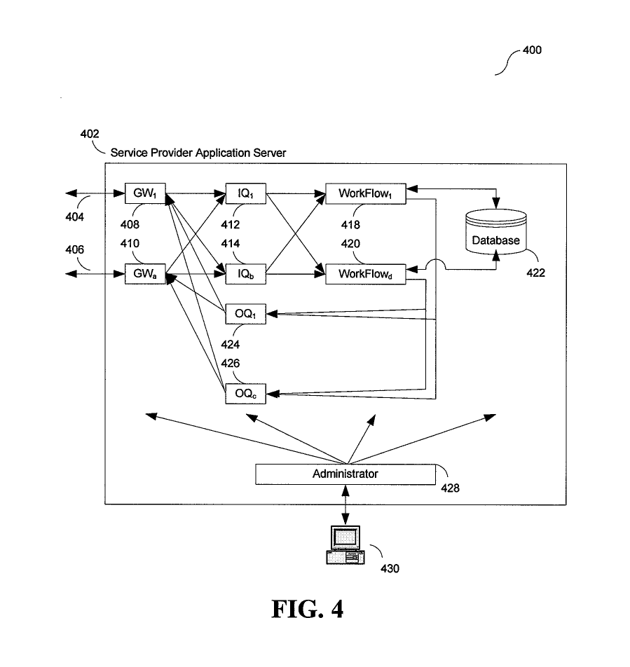

Before continuing with our illustrative example note is made of FIG. 4 and reference numeral 400, which provide a diagrammatic presentation of aspects of an exemplary SP AS 402. The illustrated AS 402 contains several key components Gateways (GW, GW₁ 408→GWₐ 410 in the diagram), Incoming Queues (IQ, IQ₁ 412→IQ_{b} 414 in the diagram), WorkFlows (WF, WorkFlow₁ 418→WorkFlow_{d} 420 in the diagram), Database 422, Outgoing Queues (OQ, OQ₁ 424→OQ_{c} 426 in the diagram), and an Administrator 428. It will be readily apparent to one of ordinary skill in the relevant art that numerous other components are possible within an AS 402.

A dynamically updateable set of one or more Gateways (GW₁ 408→GWₐ 410 in the diagram) handle incoming (e.g., SMS/MMS/IMS/etc. messaging, etc.) traffic and outgoing (e.g., SMS/MMS/IMS/etc. messaging, etc.) traffic. Incoming traffic is accepted and deposited on an intermediate or temporary Incoming Queue (IQᵢ 412→IQ_{b} 414 in the diagram) for subsequent processing. Processed artifacts are removed from an intermediate or temporary Outgoing Queue (OQ₁ 424→OQ_{c} 426 in the diagram) and then dispatched.

A dynamically updateable set of one or more Incoming Queues (IQ₁ 412→IQ_{b} 414 in the diagram) and a dynamically updateable set of one or more Outgoing Queues (OQ₁ 424→OQ_{c} 426 in the diagram) operate as intermediate or temporary buffers for incoming and outgoing traffic.

Through flexible, extensible, and dynamically updatable configuration information a WorkFlow component may be quickly and easily realized to support any number of activities. A dynamically updateable set of one or more WorkFlows (WorkFlow₁ 418→WorkFlow_{d} 420 in the diagram) remove incoming traffic from an intermediate or temporary Incoming Queue (IQᵢ 412→IQ_{b} 414 in the diagram), perform all of the required processing operations (explained below), and deposit processed artifacts on an intermediate or temporary Outgoing Queue (OQ₁ 424→OQ_{c} 426 in the diagram).

As noted above, a WorkFlow component may be quickly and easily realized to support any number of activities. For example, WorkFlows might be configured to support a user registration process; to support the receipt and processing of incoming (SMS, MMS, IM, etc.) messages (more about this below); to support the generation and dispatch of outgoing confirmation, update, response, etc. messages; to support various billing transactions; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

The Database 422 that is depicted in FIG. 4 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

As depicted in FIG. 4 an Administrator 428 provides management or administrative control over all of the different components of an AS 402 through, as one example, a World Wide Web (WWW)-based interface 430. It will be readily apparent to one of ordinary skill in the relevant art that numerous other interfaces (e.g., a data feed, an Application Programming Interface [API], etc.) are easily possible.

A SP may maintain a repository (e.g., a database) into which selected details of all administrative, messaging, etc. activities may be recorded. Among other things, such a repository may be used to support:

1) Scheduled (e.g., daily, weekly, etc.) and/or on-demand reporting with report results delivered through SMS, MMS, IMS, etc. messages; through E-Mail; through a WWW-based facility; etc.

2) Scheduled and/or on-demand data mining initiatives (possibly leveraging or otherwise incorporating one or more external data sources) with the results of same presented through Geographic Information Systems (GISs), visualization, etc. facilities and delivered through SMS, MMS, IMS, etc. messages; through E-Mail; through a WWW-based facility; etc.

Returning to our illustrative example . . . . In FIG. 3 the exchanges that are collected under the designation Set 1 and Set 2 represent the activities that might take place as (SMS, MMS, etc.) messages are routed by the various WCs (WC₁ 312→WCₙ 314) to a MICV 316 (see 324→326) and then directed, by the MICV 316, to SPₓ 310 (see 328). It is important to note these exchanges are illustrative only and it will be readily apparent to one of ordinary skill in the relevant art that numerous other exchanges are easily possible and indeed are fully within the scope of the present invention.

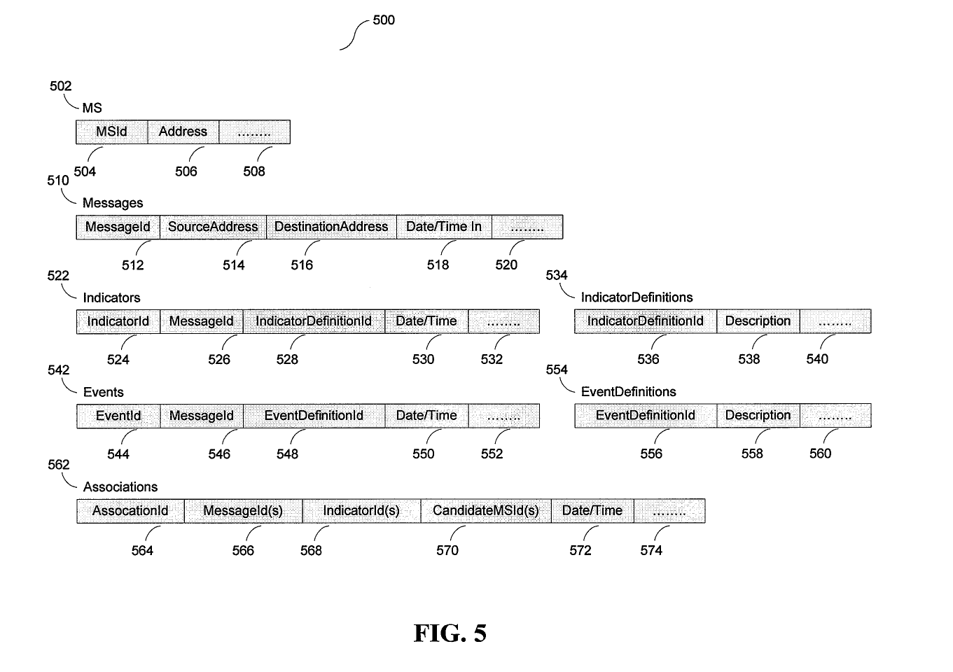

In FIG. 3 the exchanges that are collected under the designation Set 3, Set 4, and Set 5 represent the activities that might take place as (SMS, MMS, etc.) messages are processed by SPₓ 310 (see 330→340). The processing activities might include (making reference to the exemplary data model that is presented in FIG. 5 and reference numeral 500), possibly inter alia:

A) Retrieving an incoming message from an IQ.

B) Preserving various elements of the received message in a Messages table 510.

C) Updating a MS table 502, as appropriate and as required, to ensure that an entry exists for the Source Address (such as, for example, the source TN) 514 of the message.

D) Extracting from a received message, and optionally editing/validating/etc., various data elements including, inter alia, the Source Address (such as, for example, the source TN) 514, the Destination Address (such as, for example, the destination TN) 516, the message content or body, etc.

E) Performing one or more analytical steps. The analytical steps may be realized through a combination of:

i) Flexible, extensible, and dynamically configurable Workflows (as previously described) that implement the rules, logic, etc. for a range of methods (including, inter alia, statistical, keyword matching, stylistic, linguistic, heuristic, etc.) that may be applied against combinations of one or more of individual words/tokens from a message, discrete phrases from a message, an entire message, etc.

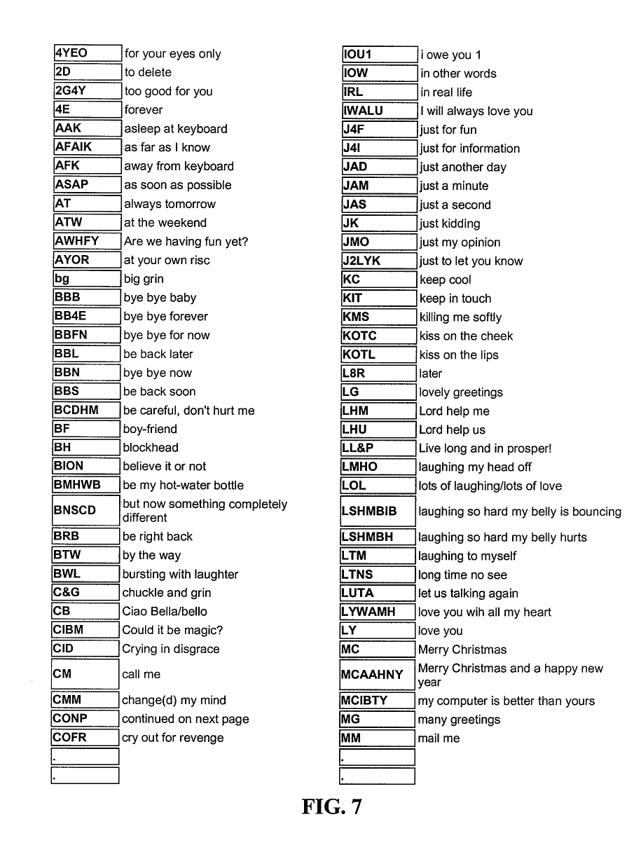

ii) Dynamically updateable data sources such as catalogs of, possibly inter alia, common expressions, shortcuts (such as illustrated in FIG. 7; for example, “wru” for “Where are you?”, “aamof” for “as a matter of fact”, “w84 mi” for “wait for me”), idioms, abbreviations, etc.; dictionaries; keywords; etc.

and may, among other things, optionally score, rate, rank, etc. the developed results; optionally augment the developed results with such things like demographic, geographic, psychographic, etc. data; etc.

F) Leveraging a flexible, extensible, and dynamically configurable list of defined indicators (e.g., as maintained in an IndicatorDefinitions table 534) generating one or more indicators. Indicators may capture, inter alia, specific characteristics, patterns, traits, features, etc.

G) Preserving one or more of the generated indicators in an Indicators table 522.

H) Leveraging a flexible, extensible, and dynamically configurable list of defined events (e.g., as maintained in an EventDefinitions table 554) generating one or more events. Events may include, inter alia, alerting one or more third parties (such as, for example, a governmental agency, a law enforcement agency, a representative of a corporation, etc.) through any combination of one or more channels such as SMS/MMS/etc. messages, e-mail messages, IM messages, telephone calls, letters, data feeds, etc.

I) Depositing one or more of the generated events on an OQ.

J) Preserving one or more of the generated events in an Events table 542.

The catalog of processing steps that were described above are illustrative only and it will be readily apparent to one of ordinary skill in the relevant art that numerous other processing steps (such as, possibly inter alia, scoring, ranking, rating, etc. one or more of the generated indicators) are easily possible and indeed are fully within the scope of the present invention.

It is important to note the exchanges that were described above (as residing under the designation Set 3, Set 4, and Set 5) are illustrative only and it will be readily apparent to one of ordinary skill in the relevant art that numerous other exchanges are easily possible and indeed are fully within the scope of the present invention.

The Set 1, Set 2, Set 3, Set 4, and Set 5 exchanges that were described above are illustrative only and it will be readily apparent to one of ordinary skill in the relevant art that numerous other exchanges are easily possible and indeed are fully within the scope of the present invention.

SPₓ may implement within its AS one or more maintenance processes that may be run or executed on a scheduled basis, on-demand, based on various trigger criteria, etc.

One such maintenance process may ‘sweep’ through an Indicators table (522 in FIG. 5) and, leveraging a flexible, extensible, and dynamically configurable set of rules, develop associations. Based on previously generated indicators an association may tie together (or associate) one or more messages based on, possibly numerous attributes but in the case of the present invention, authorship.

The results of such a sweep may be preserved in an Associations table (562 in FIG. 5) where one or more messages (Associations.MessageId(s) 566) may be associated together based on one or more indicators (Associations.IndicatorId(s) 568) and assigned one or more candidate author (possibly pseudonymous) identifiers (Associations.CandidateMSId(s) 570).

By leveraging previously generated indicators such a sweep is, among other things, efficient (e.g., it does not need to visit and analyze the underlying messages themselves), idempotent (e.g., it may be run any number of times, optionally only intelligently incrementally updating the contents of an Associations table 562 during each run), etc.

SPₓ may optionally allow some or all of the generated associations to be viewed, reviewed and/or updated by selected internal entities (e.g., authorized administrators, etc.) and/or external entities (e.g., certain registered users). For example, a SP might allow candidate author (possibly pseudonymous) identifiers (Associations.CandidateMSId(s) 570) to be reviewed, possibly narrowed or otherwise refined, etc.

The maintenance process discussion that was just presented was illustrative only and it will be readily apparent to one of ordinary skill in the relevant art that numerous other activities, etc. (such as, possibly inter alia, scoring, ranking, rating, etc. one or more of the generated associations) are easily possible and indeed are fully within the scope of the present invention.

SPₓ may offer an optional registration process during which parties that are interested in using the service (i.e., aspects of the present invention) may identify themselves and provide some range of information. A registration process may be tailored (e.g., the range of information gathered, the scope of access granted, etc.) to the class of user—e.g., a member of law enforcement may complete one type of registration process, a member of a governmental agency may complete another type of registration process, and a representative of a (marketing, advertising, etc.) company may complete yet another type of registration process.

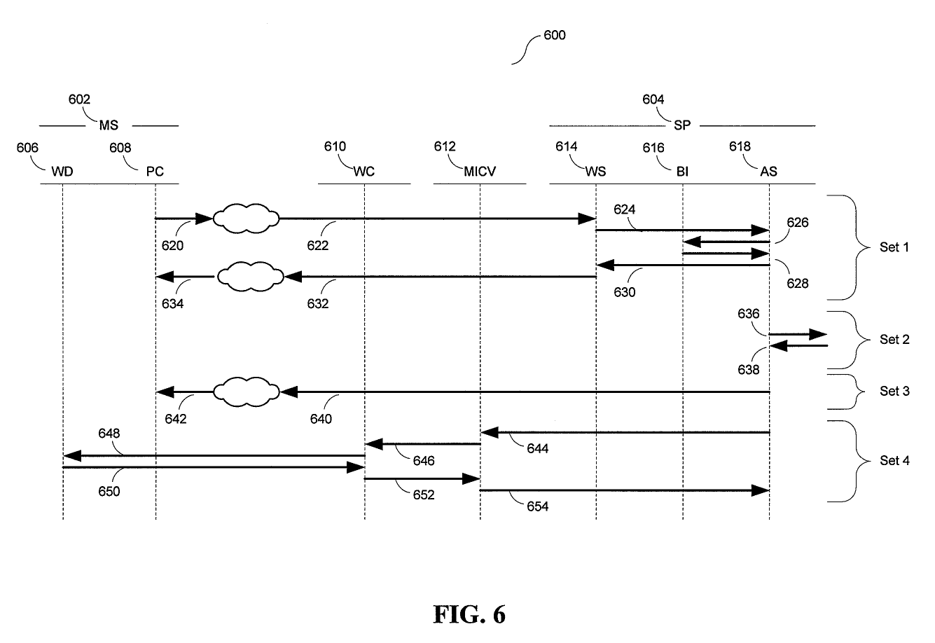

FIG. 6 and reference numeral 600 illustrate various of the exchanges or interactions that might occur during an illustrative, possibly optional, user registration process (involving a hypothetical user, Mary 602, and a our hypothetical SP, SPX 604). Of interest and note in the diagram are the following entities:

MS 602 WD 606. For example, Mary's WD such as a cellular telephone, BlackBerry, PalmPilot, etc.

MS 602 Personal Computer (PC) 608. For example, one of Mary's work, etc. PCs.

WC 610. The provider of service for Mary's WD.

MICV 612. As noted above the use of a MICV, although not required, provides significant advantages.

SP 604 Web Server (WS) 614. A publicly-available WWW site that is optionally provided by SPₓ.

SP 604 Billing Interface (BI) 616. A single, consolidated interface that SPₓ 604 may use to easily reach, inter alia, one or more external entities such as a credit card or debit card clearinghouse, a carrier billing system, a service bureau that provides access to multiple carrier billing systems, etc.

SP 604 AS 618. Facilities that provide key elements of the instant invention (which was initially described above and which will be further described below).

It is important to note that while in FIG. 6 the MS 602 WD 606 and MS 602 PC 608 entities are illustrated as being adjacent or otherwise near each other in actual practice the entities may, for example, be physically located anywhere.

In FIG. 6 the exchanges that are collected under the designation Set 1 represent the activities that might take place as Mary 602 begins an optional registration process with SPₓ 604. For example:

A) Mary 602 uses one of her PCs 608 to visit SPₓ's 604 WS 614 to, possibly among other things, complete a service registration process (see 620→622).

B) SPₓ's 604 WS 614 interacts with SPₓ's 604 AS 618 to, possibly among other things, commit some or all of the information that Mary provided to a data repository (e.g., a database), optionally complete a billing transaction, etc. (see 624).

C) As appropriate and as required a BI 616 completes a billing transaction (see 626→628).

D) SPₓ's 604 WS 614 responds appropriately (e.g., with the presentation of a confirmation message, etc.) (see 632→634).

The specific exchanges that were described above (as residing under the designation Set 1) are illustrative only and it will be readily apparent to one of ordinary skill in the relevant art that numerous other exchanges are easily possible and indeed are fully within the scope of the present invention. For example, the collected information may be reviewed, confirmed, etc. through one or more manual and/or automatic mechanisms. For example, the registration process may be completed through any combination of one or more channels including, inter alia, the indicated WWW facility, wireless messaging (SMS, MMS, IMS, etc.), E-mail messages, IM exchanges, conventional mail, telephone, Interactive Voice response (IVR) facilities, etc.

During the registration process that was described above a range of information may be captured from a candidate user including, inter alia:

1) Identifying Information (e.g., general information about Mary). For example, possibly among other things, a unique identifier and a password, optionally a pseudonym or handle, name, classification (e.g., such as, inter alia, member of law enforcement, representative of a corporation, etc.), physical address, etc.

2) Notification Information. For example, optional contact information (such as, inter alia, TNs, e-mail addresses, IM addresses, physical addresses, etc.) that SPₓ's AS may optionally include in one or more of its event generation steps (that were described previously) for the dispatching of alerts.

3) Billing Information. Different service billing models may be offered by SPₓ including, possibly inter alia, free (e.g., possibly advertising-based), a fixed one-time charge, a recurring (hourly, daily, monthly, etc.) fixed charge, a recurring (hourly, daily, monthly, etc.) variable charge, a per-use charge, etc. Different payment mechanisms may be supported by SPX including, possibly among other things, credit or debit card information, authorization to place a charge on a MS's phone bill, etc.

4) Target Information. For example, optional identifying information (such as, inter alia, message addresses such as TNs, message keywords, etc.) for the ‘targets’ of interest that SPₓ's AS may optionally include in one or more of its analytical steps (that were described previously).

5) Other Information. Additional, possibly optional, information such as age, sex, preferences and interests, etc.

The specific pieces of information that were described above are illustrative only and it will be readily apparent to one of ordinary skill in the relevant art that numerous other pieces of information are easily possible and indeed are fully within the scope of the present invention.

As noted above the information that Mary provided during the registration process may be preserved in a data repository (e.g., a database) and may optionally be organized as a MS Profile.

The content of Mary's profile may optionally be augmented by SPX. For example, one or more internal or external sources of consumer, demographic, geographic, psychographic, corporate, etc. information may be leveraged to selectively enhance or augment elements of Mary's profile.

As noted above, a SP's BI may optionally complete one or more billing transactions. A billing transaction may take any number of forms and may involve different external entities (e.g., a WC's billing system, a carrier billing system service bureau, a credit or debit card clearinghouse, etc.). A billing transaction may include, inter alia:

1) The appearance of a line item charge on the bill or statement that a MS receives from her WC. Exemplary mechanics and logistics associated with this approach are described in, for example, pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

In FIG. 6 the exchanges that are collected under the designation Set 2 represent the activities that might take place as SPₓ 604 optionally coordinates, etc. with one or more external entities to, possibly among other things, secure access, arrange to receive updates, etc. (see 636→638).

The specific exchanges that were described above (as residing under the designation Set 2) are illustrative only and it will be readily apparent to one of ordinary skill in the relevant art that numerous other exchanges (including, inter alia, updates to various of the information in a MS Profile in a SP's repository, etc.) are easily possible and indeed are fully within the scope of the present invention.

In FIG. 6 the exchanges that are collected under the designation Set 3 represent the activities that might take place as SPₓ 604 dispatches to Mary 602 one or more confirmation e-mail messages (see 640→642).

The specific exchanges that were described above (as residing under the designation Set 3) are illustrative only and it will be readily apparent to one of ordinary skill in the relevant art that numerous other exchanges (including, inter alia, other types or forms of confirmation messages) are easily possible and indeed are fully within the scope of the present invention.

In FIG. 6 the exchanges that are collected under the designation Set 4 represent the activities that might take place as SPₓ's 604 AS 618 dispatches one or more confirmation SMS, MMS, IMS, etc. messages to Mary's 602 WD 606 (see 644→648) and Mary 602 replies or responds to the message(s) (see 650→654). In the instant example the messages are shown traversing a MICV 612. The SP may employ a Short Code (SC) or a regular TN as its source address (and to which it would ask users of its service to direct any reply messages). While the abbreviated length of a SC (e.g., five digits for a SC administered by Neustar under the Common Short Code [CSC] program) incrementally enhances the experience of a MS (e.g., the MS need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

The specific exchanges that were described above (as residing under the designation Set 4) are illustrative only and it will be readily apparent to one of ordinary skill in the relevant art that numerous other exchanges are easily possible and indeed are fully within the scope of the present invention.

The Set 1, Set 2, Set 3, and Set 4 exchanges that were described above are illustrative only and it will be readily apparent to one of ordinary skill in the relevant art that numerous other exchanges are easily possible and indeed are fully within the scope of the present invention.

The registration information that was described above may be subsequently managed (e.g., existing information may be edited or removed, new information may be added, etc.) through any combination of one or more channels including, inter alia, a SP's WWW facility, wireless messaging (SMS, MMS, IMS, etc.), e-mail messages, IM exchanges, conventional mail, telephone, IVR facilities, etc.

SPₓ may optionally allow a specific (SMS, MMS, IM, etc.) message to be injected into the system so that the identity of the true author of the message may be ascertained. A SP may optionally restrict such a capability to selected users (e.g., law enforcement). A SP may also optionally restrict such a capability to users who have previously completed a registration process.

For such an injected message SPₓ's AS may complete a range of processing activities including, inter alia:

1) Performing one or more analytical steps (as described above).

2) Generating one or more indicators (as described above) that are identified through, for example, IndicatorDefinitions.IndicatorDefinitionId (536 in FIG. 5).

3) Retrieving from the Associations table (562 in FIG. 5) one or more records that contain matching indicators (e.g., as found through the chain Associations.IndicatorId(s) 568→Indicators.IndicatorId→524 Indicators.IndicatorDefinitionId 528, all in FIG. 5).

4) Retrieving from the Messages table (510 in FIG. 5) the identified messages (e.g., through Associations.MessageId(s) 566 in FIG. 5).

In response to an injected message, SPX may optionally generate a response (SMS, MMS, IM, e-mail, etc.) message containing, possibly inter alia, a list of (previously captured) messages that are possibly/likely/etc. to have been authored by the author of the injected message; a list of candidate message author (possibly pseudonymous) identifiers; etc.

A SP may optionally provide any number of value-add additions to the core functionality that was described hitherto. Such additions may carry an incremental (one-time, recurring, etc.) fee or charge. For example:

1) For an injected message a SP may optionally allow for authoritative authorship designation—i.e., the designation that the author of the injected message is (authoritatively) ‘X’ (e.g., a particular WD TN, etc.). In such a case a SP may, possibly inter alia, optionally update its previously-generated message authorship information (e.g., as preserved in Associations.CandidateMSId(s) 570 in FIG. 5) and flag such updates as inviolate. A SP may elect to restrict such a capability to selected users such as law enforcement agencies, etc.

2) A SP may optionally allow different subsets of data (e.g., generated indicators in the Indicators table, etc.) to be viewed, reviewed, and/or updated by selected internal entities (e.g., authorized administrators, etc.) and/or external entities (e.g., certain registered users).

3) A SP may optionally support multiple base languages (such as, for example, English, French, Spanish, etc.) and optionally perform internal language conversion (translation) operations as appropriate and as required.

4) A SP may optionally preserve Location-Based Services (LBS)/Global Positioning System (GPS) information, if it is available, with its captured messages (e.g., in its Messages table, such as 510 in FIG. 5). Additionally, if it is available a SP may optionally return such LBS/GPS information in response message(s).

The (confirmation, report, alert, event, response, etc.) message(s) that were described above may optionally contain an informational element—e.g., a public service announcement, a relevant or applicable factoid, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a LBS/GPS facility).

A SP may optionally allow advertisers to register and/or provide (e.g., directly, or through links/references to external sources) advertising content.

The message(s) that were described above may optionally contain advertising—e.g., textual material if an SMS model is being utilized, multimedia (images of brand logos, sound, video snippets, etc.) material if an MMS model is being utilized, etc. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a GPS/LBS facility).

The message(s) that were described above may optionally contain promotional materials, coupons, etc. (via, possibly inter alia, text, still images, video clips, etc.).

It is important to note that while aspects of the discussion that was presented above focused on the use of TNs, it will be readily apparent to one of ordinary skill in the relevant art that other message address identifiers are equally applicable and, indeed, are fully within the scope of the present invention.

The discussion that was just presented referenced several specific wireless messaging paradigms including SMS and MMS. However, it is to be understood that it would be readily apparent to one of ordinary skill in the relevant art that other messaging paradigms (IMS, IM, e-mail, etc.) are fully within the scope of the present invention.

It is important to note that the hypothetical example that was presented above, which was described in the narrative and which was illustrated in the accompanying figures, is exemplary only. It is not intended to be exhaustive or to limit the invention to the specific forms disclosed. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| API | Application Programming Interface |
| AS | Application Server |
| BI | Billing Interface |
| CSC | Common Short Code |
| DB | Database |
| DBMS | Database Management System |
| E-mail | Electronic Mail |
| GIS | Geographic Information System |
| GPS | Global Positioning System |
| GW | Gateway |
| IM | Instant Messenger |
| IMS | IP Multimedia Subsystem |
| IP | Internet Protocol |
| IQ | Incoming Queue |
| IVR | Interactive Voice Response |
| LBS | Location Based Services |
| MICV | Messaging Inter-Carrier Vendor |
| MMS | Multimedia Message Service |
| MS | Mobile Subscriber |
| ODBMS | Object Database Management System |
| OQ | Outgoing Queue |
| PC | Personal Computer |
| RDBMS | Relational Database Management System |
| SC | Short Code |
| SMS | Short Message Service |
| SP | Service Provider |
| 3P | Third Party |
| TN | Telephone Number |
| WAP | Wireless Application Protocol |
| WC | Wireless Carrier |
| WD | Wireless Device |
| WF | WorkFlow |
| WS | Web Server |
| WWW | World-Wide Web |

What is claimed is:

1. In a wireless messaging environment, a method comprising:
retrieving a plurality of messages passing through a wireless messaging environment;
preserving elements of the messages in a database;
processing the elements of the messages to make associations among the elements of the messages;
identifying patterns in the elements of the messages;
storing in the database the patterns as a plurality of associations; and
determining probable common authorship of given messages based on the patterns and the plurality of associations.

2. The method of claim 1, further comprising sending an alert to a law enforcement agency based on a result of said determining step.

3. The method of claim 1, further comprising receiving the plurality of messages at a messaging inter-carrier vendor (MICV).

4. The method of claim 3, further comprising passing the plurality of messages to a service provider that is unaffiliated with the MICV.

5. The method of claim 1, further comprising comparing a newly-received message with the patterns and the plurality of associations, and identifying other messages that may have been sent by the author of the newly-received message.

6. The method of claim 1, wherein the patterns are based on keywords.

7. The method of claim 5, wherein the patterns are based on linguistic style.

8. The method of claim 5, wherein the patterns are based on discrete phrases.

9. The method of claim 1, wherein the plurality of messages comprises short message service (SMS) messages.

10. The method of claim 1, wherein the plurality of messages comprises multimedia message service (MMS) messages.

11. A method of tracking messages sent by a person from different wireless devices, comprising:
collecting electronic message traffic from wireless devices;
processing the electronic message traffic by parsing elements of respective messages in the electronic message traffic;
analyzing the elements and identifying patterns among the elements and, thereby, among respective messages in the electronic message traffic;
storing, in an associations database, a listing of identified patterns; and
correlating given ones of the messages in the electronic message traffic with given ones of the identified patterns.

12. The method of claim 11, further comprising associating an author with the given ones of the messages.

13. The method of claim 12, further comprising refining the step of associating an author as time progresses and additional electronic message traffic is collected.

14. The method of claim 12, further comprising tracking respective times of transmission of the given ones of the messages.

15. The method of claim 12, further comprising determining prior locations of the author based on locations of initial transmission of respective ones of the given ones of the messages.

16. The method of claim 12, wherein the electronic message traffic comprises short message service (SMS) electronic message traffic.

17. The method of 16, further comprising correlating source telephone numbers of the author.

18. The method of claim 17, further comprising determining to which ones of a plurality of possible wireless carriers the telephone numbers belong.

19. The method of claim 18, further comprising determining a service payment arrangement for the author.

20. A method of determining authorship of a plurality of short message service (SMS) messages, comprising:
collecting SMS message traffic originating from wireless devices;
processing the SMS message traffic by parsing elements of respective SMS messages in the SMS message traffic;
analyzing the elements and identifying patterns among the elements and, thereby, among respective SMS messages in the SMS message traffic;
storing, in an associations database, a listing of identified patterns; and
correlating given ones of the SMS messages in the SMS message traffic with given ones of the identified patterns and thereby designate a single author of the given ones of the SMS messages.

21. The method of claim 20, wherein the patterns are based on keywords.

22. The method of claim 20, wherein the patterns are based on linguistic style.

23. The method of claim 20, wherein the patterns are based on discrete phrases.

24. The method of claim 20, further comprising collecting the SMS message traffic from a plurality of mobile telephone carriers.

25. The method of claim 24, further comprising receiving the SMS message traffic at a messaging inter-carrier vendor (MICV).
